(19) United States
(12) Patent Application Publication
(10) Pub. No.: US 2018/0275299 A1
(43) Pub. Date: Sep. 27, 2018

(54) Acoustic Underground Infrastructure Locating and Mapping System

(71) Applicant: Cartacoustics, LLC, Conifer, CO (US)

(72) Inventor: Grey M. Tarkenton, Bailey, CO (US)

(21) Appl. No.: 15/923,825

(22) Filed: Mar. 16, 2018

Related U.S. Application Data
(60) Provisional application No. 62/474,741, filed on Mar. 22, 2017.

(51) Int. Cl. G01V 1/24; G01V 1/30; G01V 1/00

(52) U.S. Cl. CPC G01V 1/247; G01V 1/245; G01V 1/005; G01V 1/301

(57) ABSTRACT

A system and method for detecting underground infrastructure that include generating analog transmit signals, receiving analog receive signals, and digitizing and recording the receive signals; amplifying analog transmit signals, converting the amplified analog transmit signals into acoustic signals, and adjusting a power and coupling of the acoustic signals to the ground; and combining the digitized and recorded receive signals to generate position data of the detected underground infrastructure.

### CROSS-REFERENCE TO RELATED APPLICATIONS

This application claims the benefit of U.S. Provisional Application No. 62/474,741, filed on Mar. 22, 2017, which application is hereby incorporated herein by reference.

### TECHNICAL FIELD

The present invention relates generally to a system and method of acoustic locating and mapping of underground infrastructure.

### BACKGROUND

Several types of systems exist for locating underground utilities to prevent damaging them during subsequent construction projects or to find them for repair. These include physical probes, magnetometers, pre-placed transmitters and ground-penetrating radar (“GPR”). GPR systems have limited range; inductive systems are not very accurate; and transponder type systems only work if the transponder is put in place during construction and has power available. These systems merely locate the infrastructure; they do not correlate the infrastructure to other surface structures and do not provide a complete picture of the location of the lines. Thus, there is a need for an accurate, inexpensive system for locating and mapping underground infrastructure, independent of function.

### SUMMARY

According to the present invention, an inexpensive system and method detects underground utilities without the problems of radar and other previous systems. It has distinct advantages over those other systems in that the transmitter and receivers are not collocated, enabling 3D mapping and being able to “see” underneath existing structures. The system and method can also survey a much larger area in shorter time compared to other previous systems.

According to embodiments, an acoustic system for detecting underground utilities comprises a controller, generating a variety of acoustic waveforms including: pulsed and continuous, at different frequencies and different chirps, and having different pulse repetition frequencies, variable pulse shapes and pulse lengths and variable duty cycles. The controller also digitizes and records the received signals at adjustable digitization rates and it combines multiple pulses together to increase signal-to-noise; a sonic transmitter having an actuator, impedance matching network and sized for optimal coupling of sound into the ground. Transmitter configurations include air-based and water-based loudspeakers and matching networks (loudspeaker positioned in a tube, underwater speaker positioned in a water column, and steel rod actuators, as well other transmitter configurations); a receiver having a plurality of sensors and amplification; and a signal processing system that combines the signal returns from the receivers using a multitude of algorithms (time-difference of arrival (“TDOA”), angle of arrival (“AOA”), constrained matched-filtering (“CMF”) and modes (incoherent pulse collections, coherent continuous collections, coherent pulsed collections) to determine 3D position information. This processing also incorporates propagation speed varying with depth, and collates individual returns into larger, coherent structures such as pipes and tanks. The signal processing system outputs the 3D data in standard formats such as computer-aided design (“CAD”), geographic information systems (“GIS”) and building integrated modeling (“BIM”) formats.

Transmitters and receivers are connected to the controller through cables or a wireless local area network, and can have intrinsic relative positioning technology (such as global positioning system (“GPS”) capability, Bluetooth capability, or WiFi-based capability) for automated positioning of the sensors, and can be located on the surface or located in underground structures such as pipes, boreholes, manholes, in an embodiment. Standard surveying method for relative positioning can also be used.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a transmitter unit sending acoustic signals into the ground where the waves bounce off infrastructure and return to multiple receivers, wherein these received signals are then analyzed to determine the 3D locations of the infrastructure;

FIG. 2 shows a functional block diagram of a Field Segment (FS) portion of the system according to embodiments;

FIG. 3 shows a functional block diagram of a Processing Segment (PS) portion of the system according to embodiments;

FIG. 4 shows an implementation of an acoustic-based underground infrastructure locating and mapping system according to embodiments, including at least a controller, a transmitter, and receivers;

FIG. 5 is a schematic diagram of a transmitter implementation according to an embodiment;

FIGS. 6 (a) and 6 (b) show example multiple-transmitter footprints according to embodiments;

FIG. 6 (c) shows examples normalized receiver patterns according to embodiments;

FIG. 7 shows a multi-receiver implementation for digital beam forming;

FIG. 8 shows an embodiment of a packaged controller of the system;

FIG. 9 are graphs of raw recorded receive signals from a single site;

FIGS. 10 (a), (b), (c), (d), and (e) are associated with a first example of the signal processing method according to an embodiment, wherein:

FIG. 10 (a) displays the collection geometry in three dimensions of an embodiment with one transmitter, four distributed single receivers and a series of buried point objects;

FIG. 10 (b) are graphs of the corresponding transmitted and received signals;

FIG. 10 (c) shows an elliptical shell generated from a constant-speed model based on the arrival time computed from the received signal of the first receiver according to an embodiment;

FIG. 10 (d) shows the elliptical shells from the first and second receivers' signals;

FIG. 10 (e) shows the elliptical shells from the first, second, and third receivers' signals, wherein the single point common to all three elliptical shells is the location of the buried infrastructure generating the signals;

FIGS. 11 (a), (b), and (c) are associated with a second example of the signal processing method according to an embodiment, wherein:

FIG. 11 (a) shows elliptical shells associated with one transmitter and four receivers;

FIGS. 11 (b) and (c) show elliptical shells associated with one transmitter and three receivers, wherein the received signals are generated from an extended object (a pipe) and the shells are mutually tangent to the object instead of a mutual intersection (as in FIG. 10 (a) through (e));

FIG. 12 shows sample waveforms, correlation output, and internal formatting used as an input to the mapping step collected by field equipment prototype according to embodiments;

FIG. 13 shows an example of an output data product that can be supplied in a hard-copy report or a digital file to a customer;

FIGS. 14 (a), (b), and (c) show various acoustic signals that can be used according to embodiments;

FIG. 15 is a graph of sound speed versus depth according to an embodiment;

FIGS. 16 (a), (b), (c), (d), and (e) show signals associated with a precise locating method, according to an embodiment;

FIG. 17 shows an example of a flow chart algorithm that can be used in conjunction with receive data signal processing, according to an embodiment; and

FIG. 18 shows an example data format, according to an embodiment.

### DETAILED DESCRIPTION OF ILLUSTRATIVE EMBODIMENTS

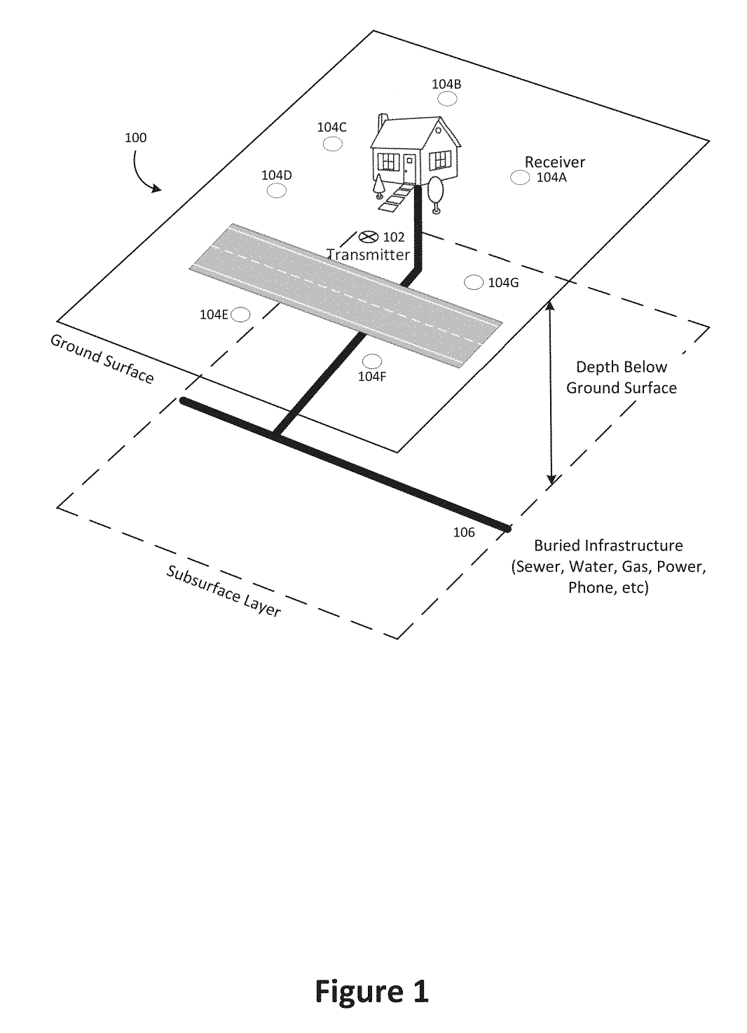

A system and method according to embodiments uses acoustic signals to probe the ground to accurately locate and map shallow underground infrastructure. FIG. 1 depicts a location in which locating and mapping of the shallow underground infrastructure is desired. FIG. 1 shows a field location 100 in which the mapping system has been temporarily installed, including, on the ground, a transmitter 102, microphones 104A, 104B, 104C, 104D, 104E, 104F, and, in the ground, infrastructure 106 including, for example, water and sewer lines. Some of the paths of the acoustic transmit and receive signals emanating from transmitter 102 and being received by the microphones are also shown as dotted lines.

These acoustic-based approaches have been exploited for years in the petroleum industry for finding underground reservoirs, and a novel extension of these approaches to the underground infrastructure locating application is described. There are at least three major differences between seismic prospecting and underground infrastructure locating, including: size, depth, and frequency. Petroleum reservoirs are enormous structures, many acres in size, while sewer pipes, water pipes and telephone cables are only inches in breadth and many feet in length; even underground tanks are small compared to geologic features. Second, the reservoirs are typically miles beneath the surface, where the soil has consolidated into rock structures with relatively uniform properties. Man-made infrastructure is normally located with about 50 feet of the surface, with the majority being between 10-20 feet down. In this zone, the material properties change significantly, implying more complex propagation dynamics and more involved processing to extract location information and perform mapping. Third and finally, seismic prospecting uses low-frequency waves, below about 100 Hz, for their work; this arises because only low frequency waves can penetrate into the deep earth to sense the structures; in the shallow earth, higher frequencies up into the 1-2 kHz range can propagate sufficiently far to sense the underground infrastructure. These higher frequencies are also important because the positioning resolution improves (meaning: finding and positioning objects at smaller scales) and that is important to usefully locating buried infrastructure objects.

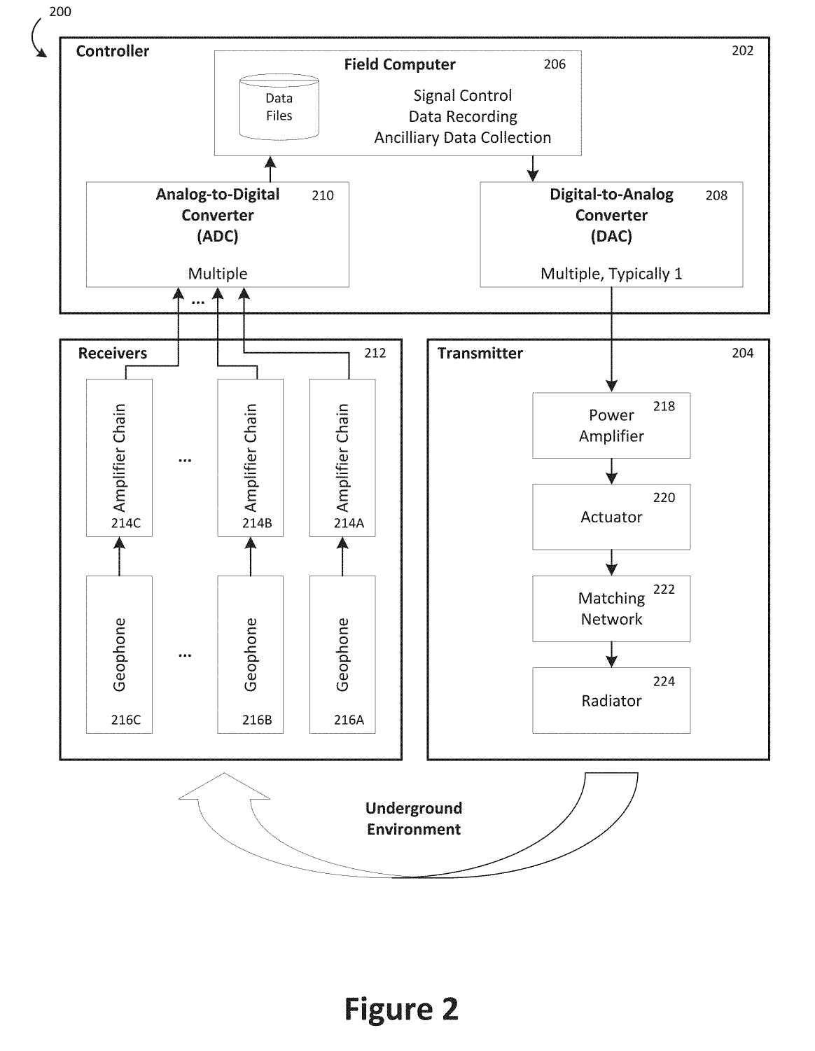

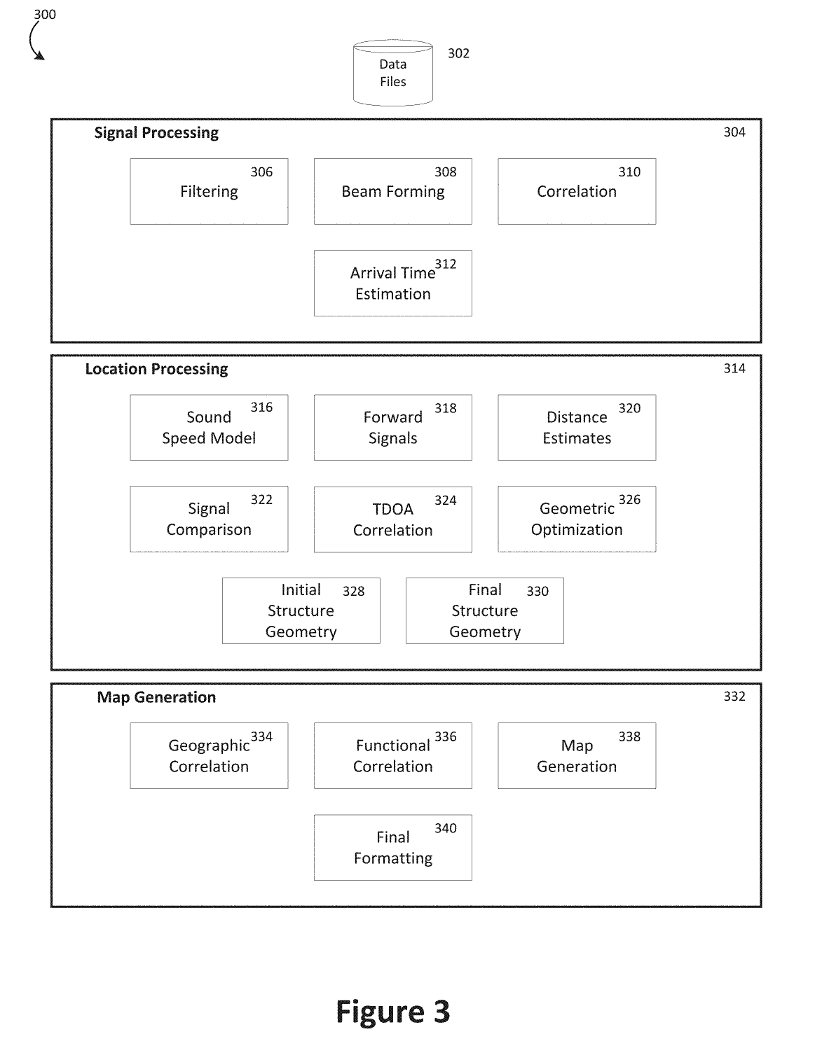

The system comprises two major segments: a Field Segment (“FS”) deployed to a collection site (as is shown in FIG. 2 and described in further detail below), and a Processing Segment (PS) that resides in a data center or can accompany the field equipment on a ruggedized computer (as is shown in FIG. 3 and described in further detail below).

FIG. 2 shows a functional block diagram 200 of the Field Segment. The Field Segment portion of the system comprises a Controller 202, a Transmitter 204 and a plurality of Receivers 212. The Controller (“CTL”) 202 generates signals, controls timing, records the input channels and generates files needed for subsequent processing. In an embodiment Controller 202 includes a field computer 206 for signal control, data recording, ancillary data collection, and storage of the data files. Controller 202 also includes a Digital to Analog Converter (“DAC”) for interfacing between the field computer 206 and the transmitter 204. One or more DACs can be used, in an embodiment. While one DAC is typically used with one transmitter, in the case where the transmitter has multiple channels for beam forming, multiple DACs can be used for converting the multiple channels. The Transmitter (“Tx”) 204 broadcasts sound into the ground according to the Controller's direction. In an embodiment, Transmitter 204 includes a power amplifier to increase the amplitude of the analog input signal from the DAC 208 to drive an actuator 220, a matching network 222, and a radiator 224 that are all described in further detail below. The Receivers (Rx's) 212 detect sound in the ground, amplify it and route the amplified signals to the Controller 202. In an embodiment, Receivers 212 comprise a plurality of geophones (microphones) 216A, 216B, 216C that can be placed according to a pattern, randomly, or strategically in various locations to optimize the location and mapping of the shallow underground infrastructure. The Transmitter 204 and Receivers 212 are both analog systems, and the Controller 202 has mixed analog and digital components. The above description is a functional description; the various functions described can be distributed in different components and different arrangements in other implementations.

FIG. 3 shows a functional block diagram 300 of a Processing Segment (PS) portion of the system. Data files 302 from the Field Segment 200 are analyzed and processed by the processing segment to eventually generate a data product supplied to a customer including a detailed map of the located underground infrastructure and other desired related information. The Processing Segment 300 includes a signal processing portion 304 including filtering 306, beam forming 308, correlation 310, and arrival time estimation 312 functions. The Processing Segment 300 also includes a location processing portion 314 including the sound speed models 316, forward signals 318, distance estimates 320, signal comparisons 322, Time Difference of Arrival (TDOA) correlation 324, geometric optimization 326, initial structure geometry 328, and final structure geometry 330 functions. Finally, the Processing Segment 300 includes a map generation portion 332 including the geographic correlation 334, functional correlation 336, map generation 338, and final formatting 340 functions.

The data files 302 generated by the Field Segment 200 initiate the Processing chain with an initial quality check of the data formats and sizes. With successful checks, the data go through various steps that analyze the raw time-based signals from each geophone individually and then in groups, based on how the field collection was performed. The ultimate output of the signal processing step is a set of arrival times of the transmitted signal at each of the geophones and optional digital beam directional information. These arrival times and optional beam data are the main input to the Location Processing portion 313. The Location Processing portion 314 uses sound speed models 316 (multiple models of increasing complexity and fidelity) with the arrival times to create initial 3D locations of underground objects consistent with the measured arrival times and sensor locations. This initial estimate is used to generate a signal model for more detailed comparison to the measured signals. Location adjustments are made and a final structure list with 3D positions is generated. This list initiates the Map Generation process that correlates the detected structures among themselves (for example to determine pipe junctions and corners) and with surface features and generates the output map in various formats.

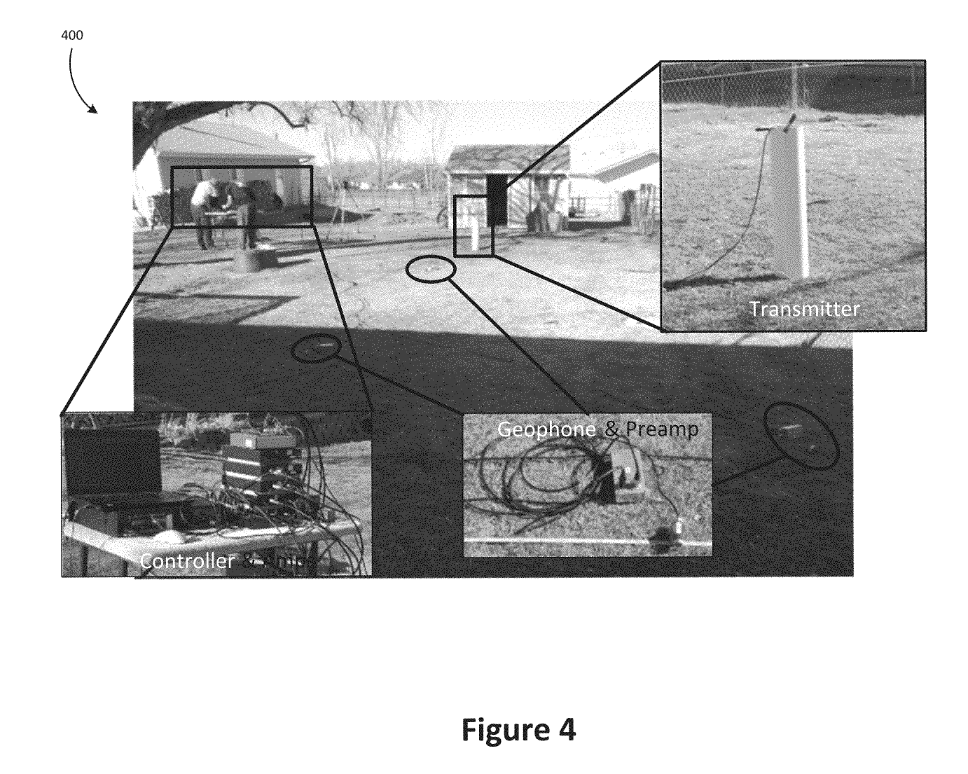

The Field Segment equipment is deployed to a location 400 where a survey is performed as is shown in FIG. 4. The Field Segment equipment is portable and is self-contained and comprises three primary parts: a transmitter 406, a set of receivers 404 and a controller 402. The transmitter 406 has an audio amplifier connected to an audio actuator, which in one embodiment is a loudspeaker. The loudspeaker is placed into an acoustic impedance matching network that optimizes the coupling of acoustic energy from the impedance medium to the ground. In one embodiment, the impedance-matching network is a resonant cavity; other instantiations can include water columns and metallic rods (not shown in FIG. 4). The processing segment associated with the Field Segment equipment can be hosted on a cloud server and is also not shown in FIG. 4.

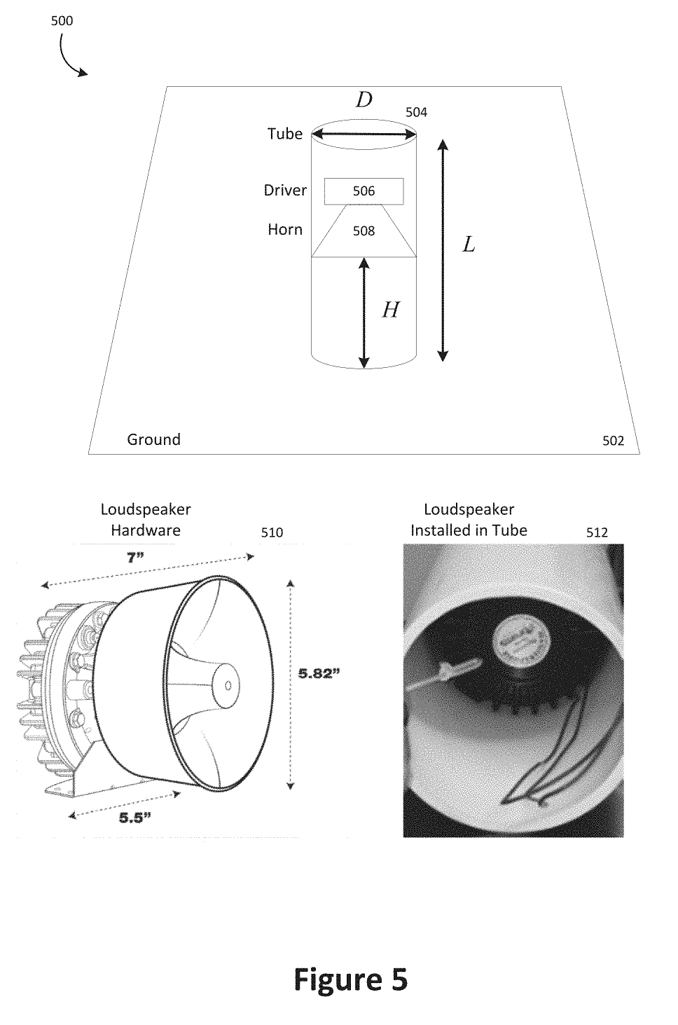

FIG. 5 shows an air-column design 500 where the resonant cavity is a tube 504 of standard PVC. The entire transmitter system is calibrated to maximize signal transmission into the ground 502 (which corresponds to standing waves for a resonant matching structure). This calibration may be adjusted by changing the distance between the speaker and the end of the tube or by changing the center frequency of the signal. This adjustability is required because the resonance/matching condition depends on the ambient temperature and humidity.

FIG. 5 thus shows a schematic diagram of an embodiment transmitter implementation. The primary structure for this transmitter is a PVC tube 504 (standard schedule-40 pipe) with a diameter D. The diameter is determined by the center sound frequency used (middle of the operational frequency range), and, in an embodiment, the inner diameter is six inches. The driver-horn combination 506 and 508 forms a standard outdoor loudspeaker with a folded horn design. In an embodiment, a commercially available “public address” loudspeaker rated to handle 200 Watts is used. The driver 506 has two electrical connections that are connected to the power amplifier (not shown in FIG. 5). The overall length, L, of tube 504 is not a critical dimension, provided it is long enough to accommodate the greatest height (H) required. The height, H, is an adjustable length set by moving the loudspeaker 508 up and down in the tube. The adjustable value of H is set in the field to generate the loudest sound. The sound level changes noticeably as the speaker is raised and lowered. The field adjustability is required because the resonant length is a function of the ambient temperature and humidity for this instantiation of transmitter.

Also shown in FIG. 5 is a depiction of the loudspeaker hardware 510, and a depiction of the loudspeaker installed in the tube 512.

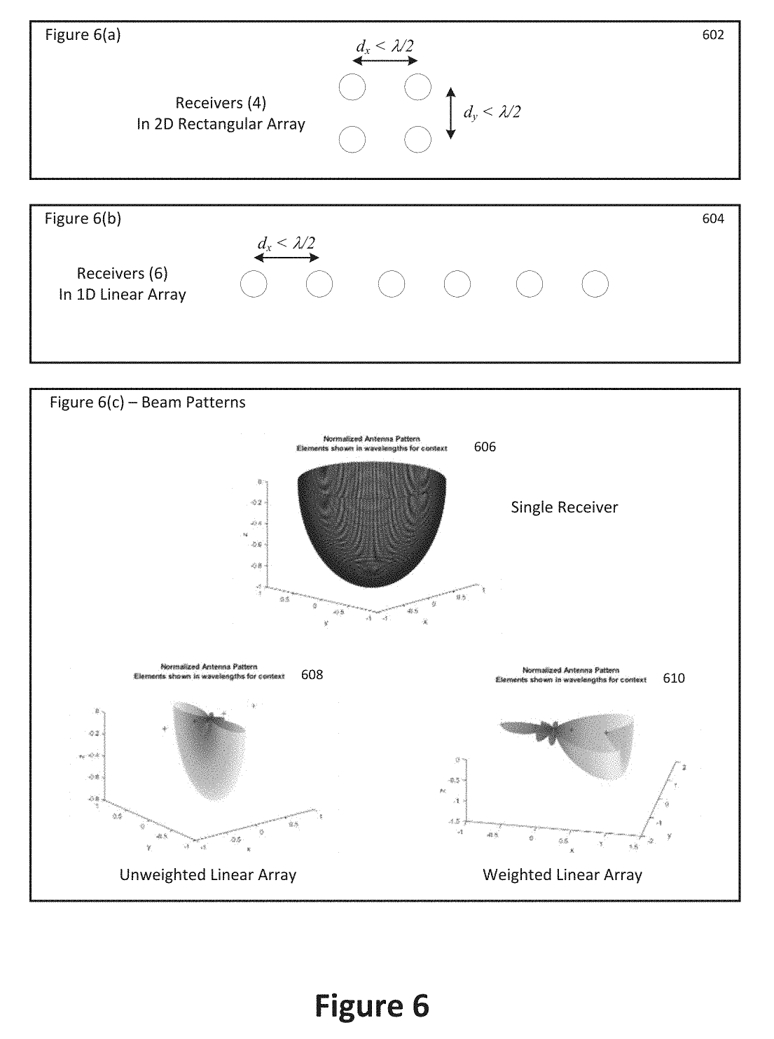

In another embodiment, the transmitter has a number of emitters (shown in FIGS. 6 (a) and (b)) and the phase between the emitters is varied to create an acoustic beam and steer the beam electronically. Altering the phase and amplitude can change the output pattern of emitters, which provides for beam steering and better angular discrimination (as is shown in FIG. 6 (c)).

FIGS. 6 (a) and (b) thus show multiple-transmitter embodiments 602 and 604, respectively. Each circle shown represents the plan view of a transmitter footprint on the ground of the tube 504 shown and described with respect to FIG. 5. The number of emitters can vary from two to as many as desired. FIG. 6 (a) shows four emitters in a square configuration, spaced a half-wavelength apart. FIG. 6 (b) shows six emitters in a linear configuration spaced a full wavelength apart. Other configurations that are possible are not shown. For example, while array-type and linear-type configurations are shown, other non-array-type and non-linear-type configurations are possible. It is an advantage that in embodiment configurations receivers can be placed in strategic locations such as in pipes, boreholes, manholes, and other locations in order to more accurately locate and map the shallow underground infrastructure. In this situation, the array pattern will often not be an array or straight line. However, other array and linear patterns with various numbers of transmitters and spacings are possible as desired. The transmitter is usually placed in a convenient spot, and receivers placed in the locations desired, because there is generally less equipment accompanying the receivers and the receivers are physically smaller than the transmitter, in an embodiment.

Thus, a transmitter array can be a two dimensional array, such as a square array or a one dimensional array, which is a linear array. Each type of array has advantages in locations different configurations of shallow underground infrastructure. Other array configurations can be used that are not shown in FIG. 6 (a) or 6 (b), which regular or irregular spacings. Transmitters and detectors can be located inside of or with infrastructure such as manholes and pipes, as well as other infrastructure types. These locations may not be able to be accommodated in an array pattern, but can be an advantage for accurately locating infrastructure that may not otherwise be possible.

FIG. 6 (c) shows plot 606 of a simple single element pattern, which shows that a single element is an isotropic monopole having almost no directional sensitivity. The middle plot 608 shows an array pattern with no imposed phase, showing that the pattern develops a natural directional sensitivity in the direction perpendicular to the array. The plot 610 on the right shows an array pattern steered 45 degrees off broadside, indicating the directional sensitivity obtained by adjusting the relative phases of the elements. These capabilities significantly enhance the locating performance over a single element. This capability improves the overall system accuracy and reliability by narrowing the insonated region in a controlled and known way. The corresponding configurations also increase the amount of acoustic power in the ground, helping to improve the overall signal-to-noise of the system.

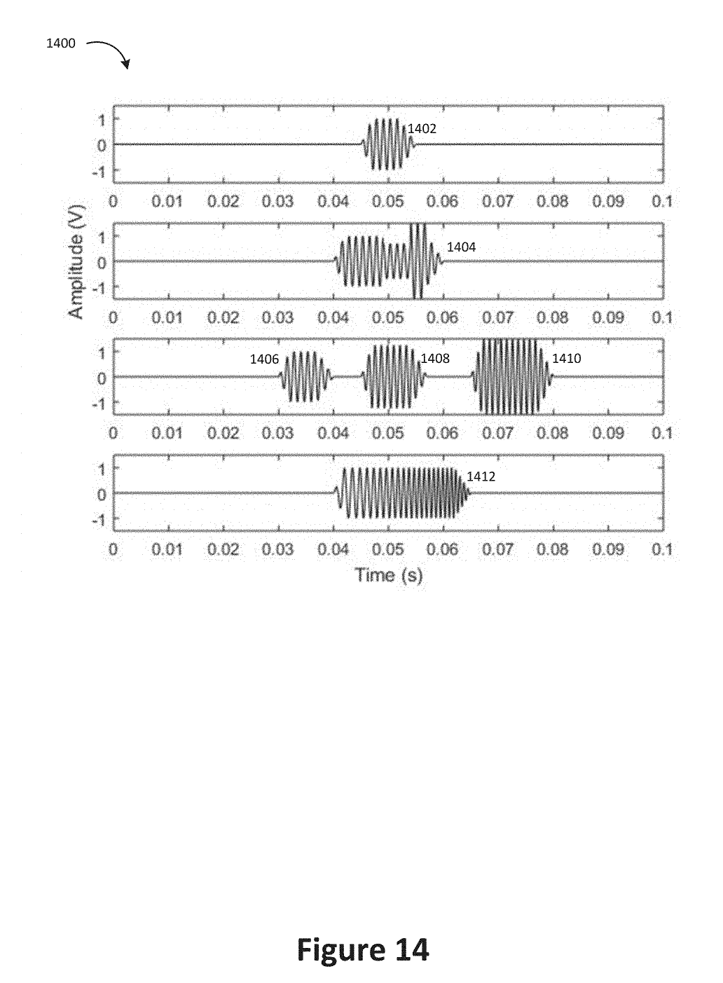

In addition to the acoustic power delivered to the ground, the acoustic signal can be optimized to achieve the best overall performance. For example, there are a number of different waveform features that can be used in embodiments. The most basic waveform is a simple pulse 1402 of acoustic energy at a single central frequency and phase Ø as is shown in FIG. 14 (a). It should be noted that in FIGS. 14 (a), (b), (c), and (d) the envelope information is only shown for sake of clarity, but that the actual sinusoidal or other waveform would be constrained by the envelope information as shown. In this configuration, the transmitter outputs sound for the pulse duration and is off for the remainder of the pulse repetition interval (“PRI”). This pulse type is used for detecting objects near the surface and directly beneath the transmitter. The next waveform that can be used comprises more complicated single pulses, with more complicated envelop shapes; these shapes can have amplitude variations and phase variations Ø₁, Ø₂, and Ø₃ that are used to improve correlation processing as is shown in waveform 1404 shown in FIG. 14 (b). These waveforms still only have a single period of transmitter activity for each pulse repetition cycle. A third waveform type comprises multiple pulses of different lengths, amplitudes, phases and spacings as is shown in pulses 1406, 1408, and 1410 shown in FIG. 14 (c). These pulse types are termed “coded pulses” because in certain implementations they resemble coded pulse sequences used in wireless communications protocols. The number of pulses and their distribution in the repetition interval are all design parameters that can be used to address different soil conditions and other specific issues related to site operations. These coded pulses further enhance detection abilities and are used for detecting deeply buried objects. The fourth and final waveform type is a “chirped pulse” 1412 shown in FIG. 14 (d) that comprises an acoustic pulse with constantly changing frequency over the pulse duration. The frequency of the pulse can change from a first frequency f₁ to a final frequency f₂, in an embodiment. A particular kind of chirped pulse is a linear frequency modulation (LFM) pulse where the frequency changes linearly in time; the change can go from a low frequency f₁ to a high frequency f₂ or the other way around. These pulses have useful features in signal processing as they effectively narrow the pulse length, which results in higher-precision locations over non-chirped pulses. All four varieties of the above described waveforms can be used depending on the application.

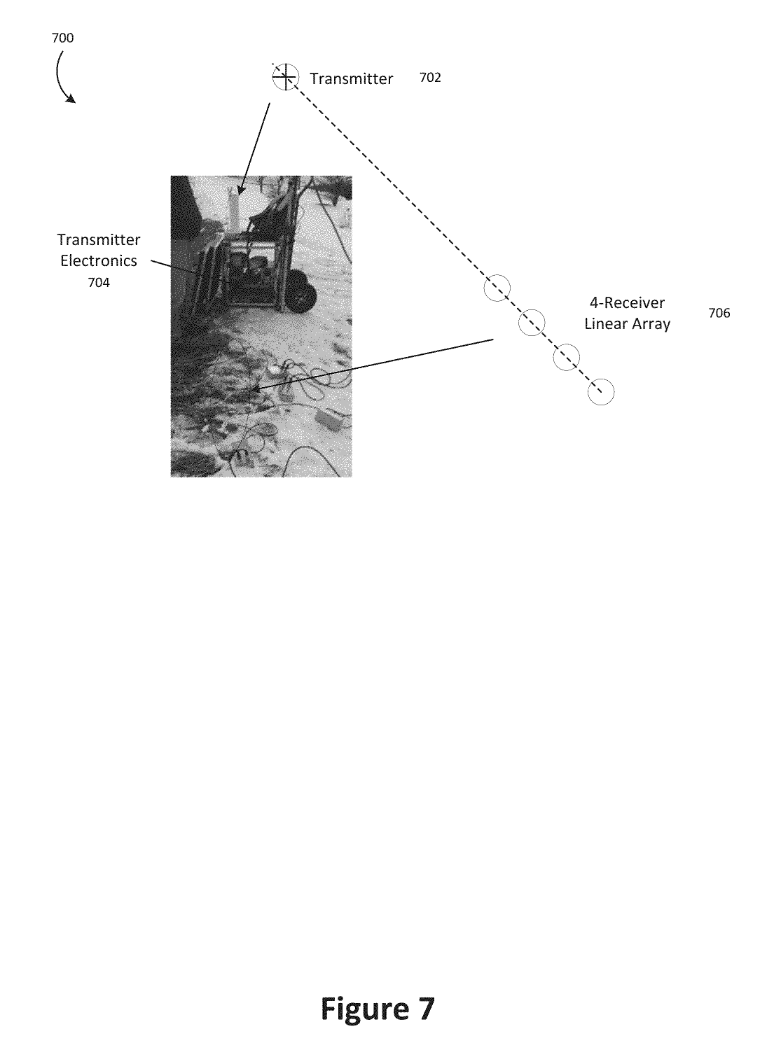

The receivers comprise audio sensors to detect acoustic signals in the ground, which are geophones in one embodiment. The receivers are placed in a semi-random pattern around the transmitter in an embodiment. Embodiment placements vary the receiver-transmitter geometry both in distance and angular coverage (angle measured about the transmitter). This diversity in placement provides an optimum approach to processing the measured data and in accurately positioning the buried infrastructure. FIG. 7 shows a first field location 700 having four receivers 706 placed in a radial line away from the transmitter 702 (and transmitter electronics 704). FIG. 4 shows a second field location showing a random placement of receivers 404 that can be accomplished either singly or in a group. Receive signals can be recorded using a single receiver by placing the receiver at one location and recording the sound, then moving it to the next and recording. The method of moving a single receiver around at various locations is a faster way to collect data in an embodiment, because it streamlines the field work of measuring the positions while recording. Multiple receivers can be grouped into shapes similar to the multi-transmitter configuration (e.g. a line of receivers) to enable beam-forming processing as is shown in FIG. 7). This group of receivers 706 can then be moved about the transmitter 702 in a similar manner to a single receiver. A configuration of receivers in this form is a line of receivers 706 oriented radially away from the transmitter as is also shown in FIG. 7. If multiple transmitters and multiple receivers are used, then beam forming on both the multiple transmitters and multiple receivers provides even higher control over the insonated region. The outputs of each audio sensor are amplified and sent to the controller for storage and processing.

FIG. 7 thus shows the multi-receiver configuration for beam forming. The four geophones 706 are set on a radial line from the transmitter 702 and in the configuration shown in FIG. 7, are spaced one-half wavelength apart (five inches in this example).

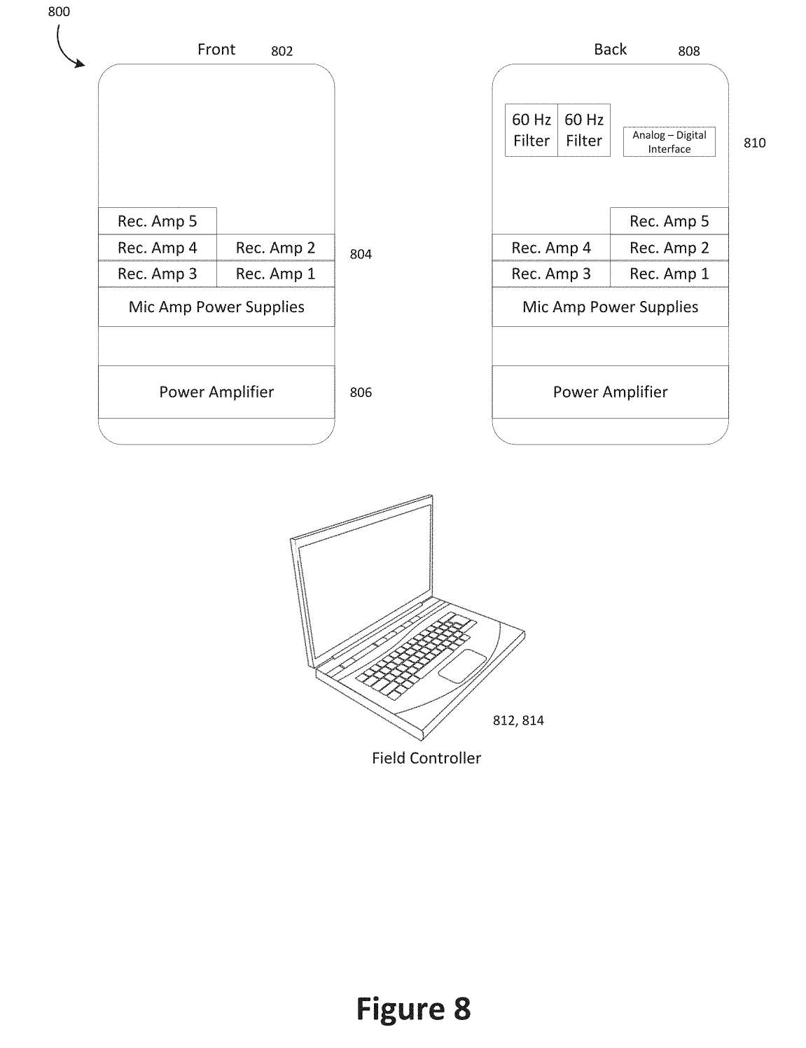

A field controller 800 is shown in FIG. 8 comprising a computer 814 shown in drawing portion 812 and an equipment interface 810 shown in drawing portion 808. The field controller 800 performs the tasks of creating the transmitted signals, recording the received signals and synchronizing the timing of all field activities. Also shown in FIG. 8 is a set of ruggedized receiver amplifiers 804 and power amplifiers 806 shown in drawing portion 802. The controller 800 with amplifiers 804 and 806 also includes 60 Hz filters, in an embodiment.

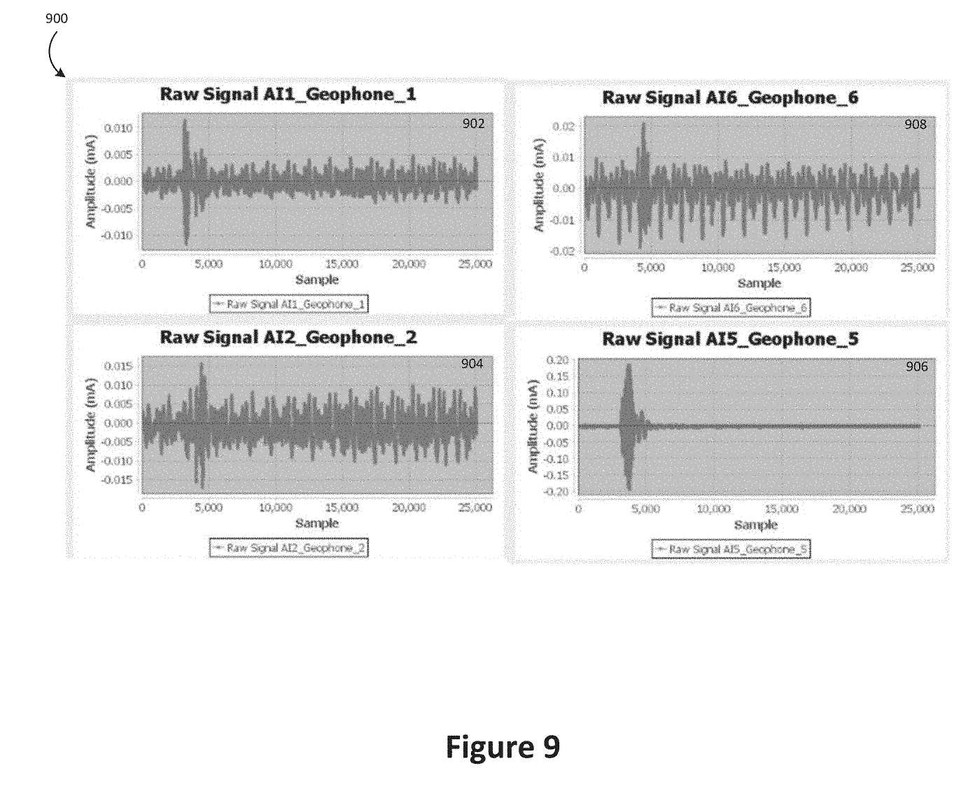

The received signals are further amplified and digitized, and in one instantiation, multiple transmitted signals are combined together to enhance the signal-to-noise ratio before being stored and sent to the processing segment. A set of received waveforms, digitized, recorded and plotted appears in FIG. 9.

The above process occurs in two different steps. The transmitter sends out multiple copies of the base waveforms one after another in time (typically a few hundred). The detected returns from each copy are added together (point-wise in time) to enhance the signal-to-noise ratio on a per-receiver basis, which is called “stacking” the return signals, in an embodiment. If the receivers are set up for beam-forming, the stacked returns for multiple receivers are combined together with different phases to form a digital beam. “N” receivers can form “N−1” beams. The combining of these returns is a point-wise sum in time of the received signal weighted by a phase factor for each receiver. Different phase factors create the different beams.

FIG. 9 thus shows raw recorded signals from a single site generated by a plurality of geophones, including Raw Signal AI1_Geophone_1 902 from a first geophone, Raw Signal AI2_Geophone_2 904 from a second geophone, Raw Signal AI6_Geophone_6 908 from a sixth geophone, and Raw Signal AI5_5 906 from a fifth geophone. The noise on the first, second, and sixth geophones is due to their proximity to a buried power line—the noise being 60 Hz which is filtered out (see subsequent figures). The large spike around the horizontal axis (representing time) value 3,000 (representing 60 ms) is the direct signal from the transmitter and subsequent bulges represent returns from buried structures. The total duration for the sequence shown is 0.5 seconds and was digitized at 50 ksps.

The processing segment is comprised of server-class computers to compute positions from signals. These servers are located in a data center in one instantiation or are collocated with the field segment in another. The signal processing comprises three major steps (as was described with respect to the block diagram of FIG. 3). The first step is the signal processing step where the signals from each receiver are filtered and correlated to identify copies of the transmitted signals. These copies have a number of properties that are extracted, such as the leading-edge arrive time, the duration of the received pulse, the amplitude profile of the received pulses. This information is stored for the next processing step. Beam forming can be done in the field to create complex signals and digital beams as was previously discussed. In this case, the output is the same as the non-beam-formed output (pulse duration, arrival time, etc.) but indexed by beam instead of receiver. Information about the beam geometry is also stored.

The next processing step uses multiple different models for sound-speed propagation in soils to determine the locations of objects that generated the scattered signals recorded and processed in the first step. As mentioned above, the sound propagation speed changes with depth as the soil consolidates. The sound speed models capture this variation. Three different models in order of increasing complexity and fidelity are described below. A first model uses a constant sound speed, where the minimum-time paths are straight lines and the constant arrival-time surfaces are ellipsoids. A second model uses a linearly increasing sound speed with depth, where the minimum-time paths are circular segments and the constant arrival-time surface take on a slightly mushroom shape. A third model is the most general and has a sound speed that changes continuously from the surface to an asymptotically constant value. The variation is modeled as an algebraic asymptote form using the following equation:

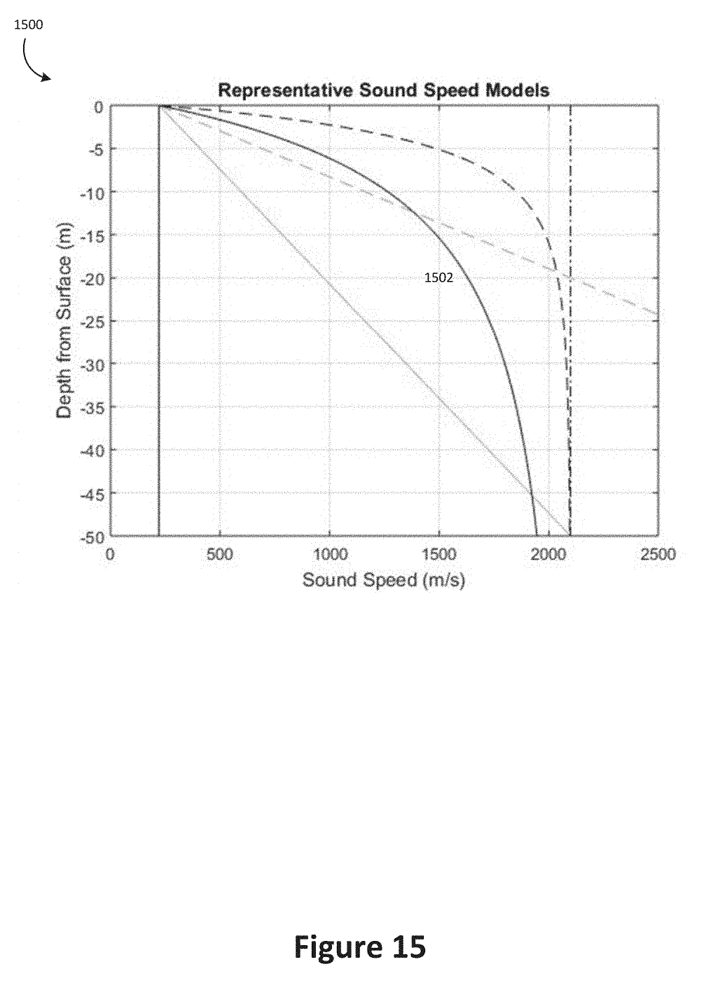

c(z)=(c_{depth}+(c_{surface}−c_{depth}))/(1+z/zₒ)̂n

wherein “c” is the calculated sound speed and “z” is depth, as is shown in the curve set 1502 of the graph of FIG. 15). The two “c” constants represent the surface sound speed (c_{surface}) and the ultimate sound speed at depth (c_{depth}). They are constants that are determined by an independent calibration step done on site, or they are inferred as part of the precision location step in the processing. As previously explained, “z” represents the depth beneath the surface and “z₀” and “n” are model parameters determined through on-site calibration or as part of the overall processing. The detailed variation from the surface value to the value at depth varies with the “n” parameter. The larger “n” is, the more sharply the sound speed “c” varies as is shown in the curves 1502 of the graph of FIG. 15. In this sound speed model, the minimum-time paths and arrival-time surfaces do not have an analytical form and are generated numerically. Signal processing using the more intuitive constant-sound-speed case can be used first to get an initial location; the more realistic and complicated models are used in later processing steps associated with higher-precision location processing. The more complicated models carry through the same steps, just with the more computational complexity and thereby yielding more accurate results.

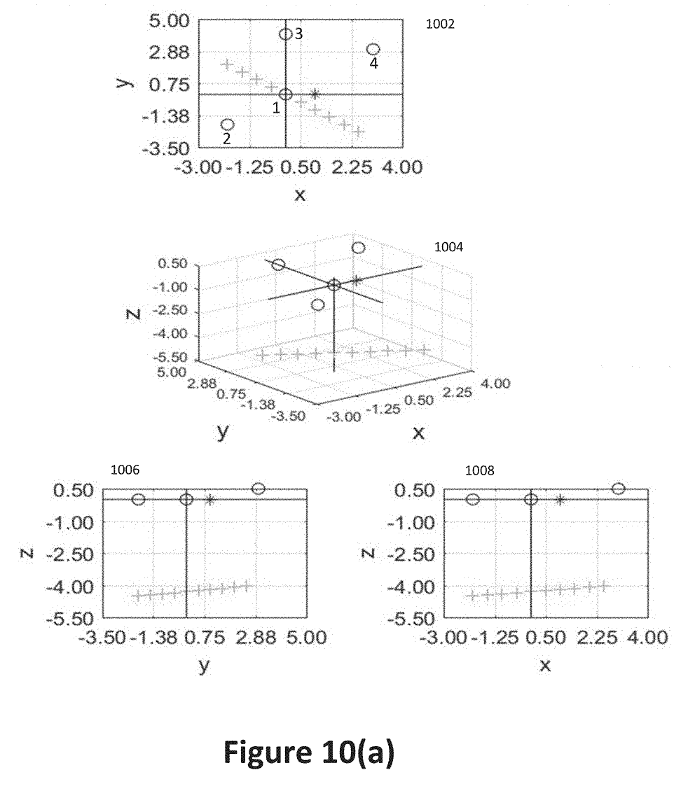

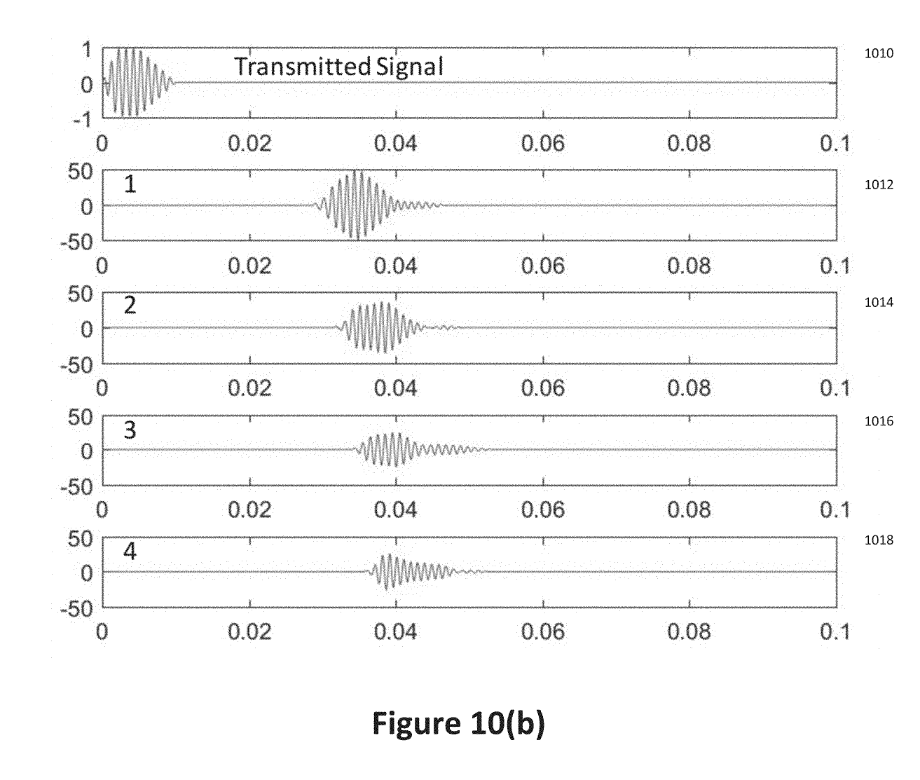

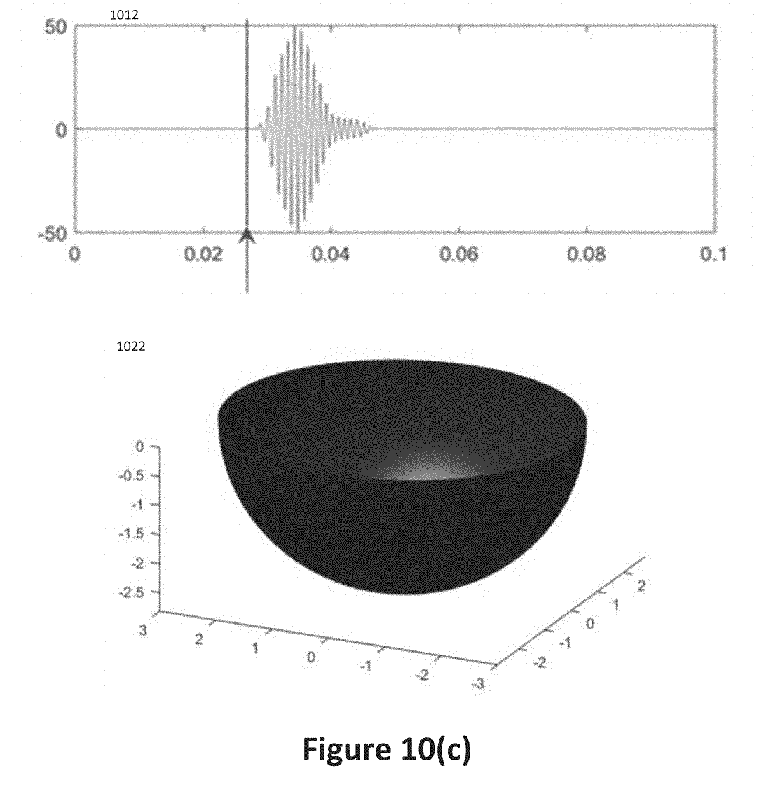

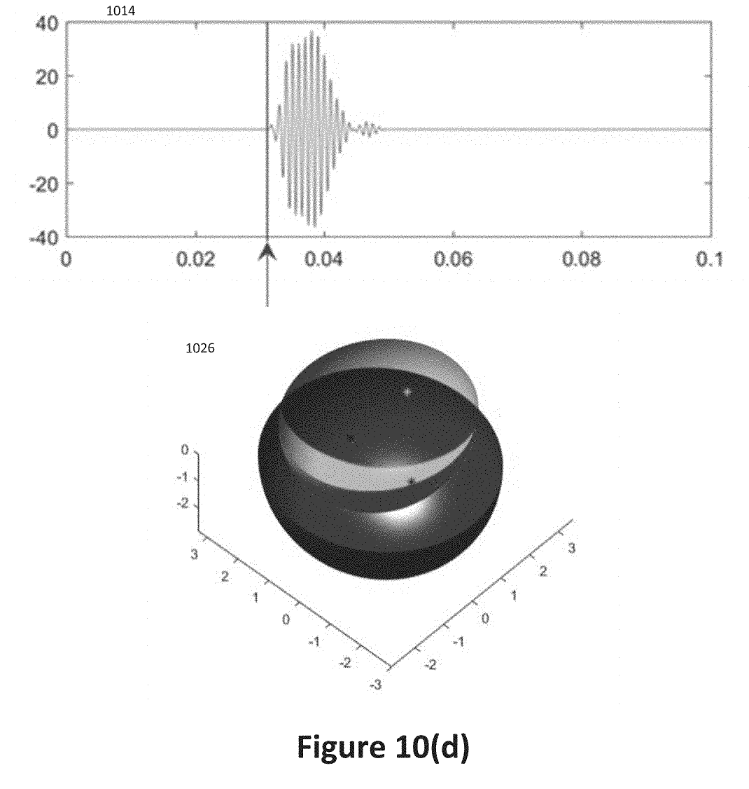

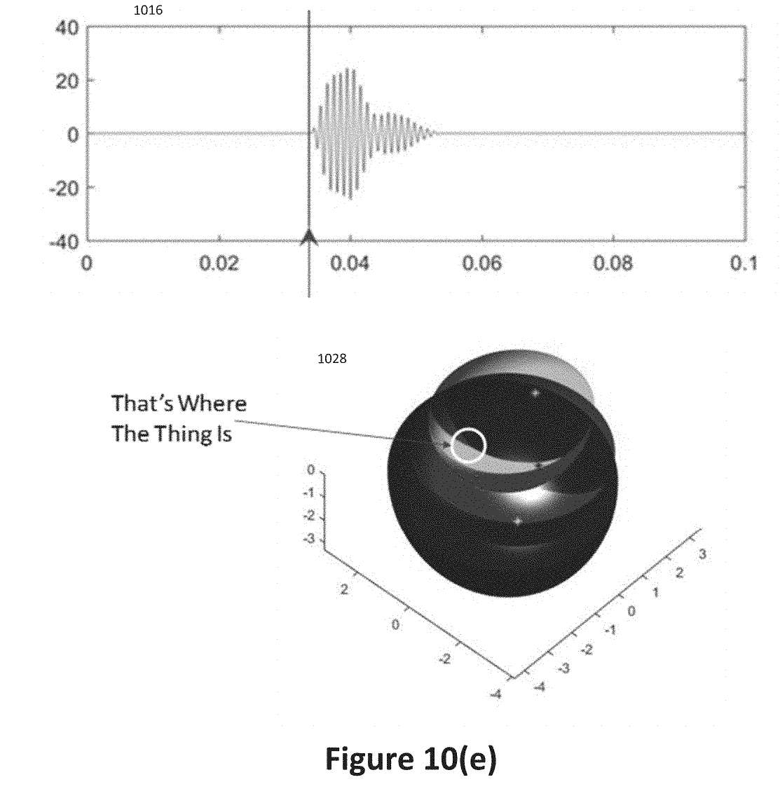

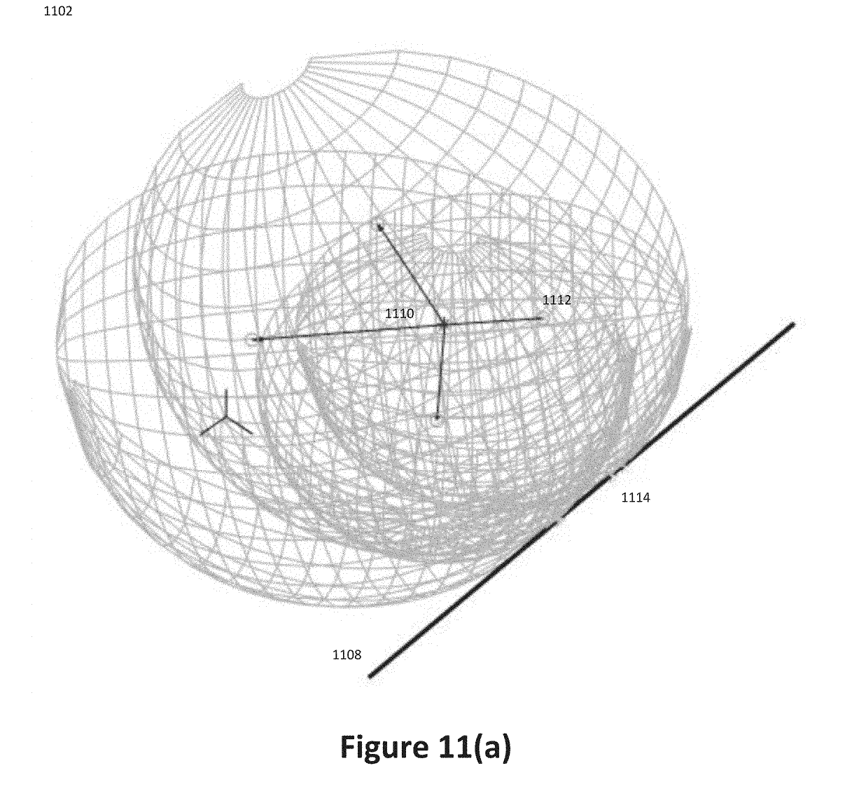

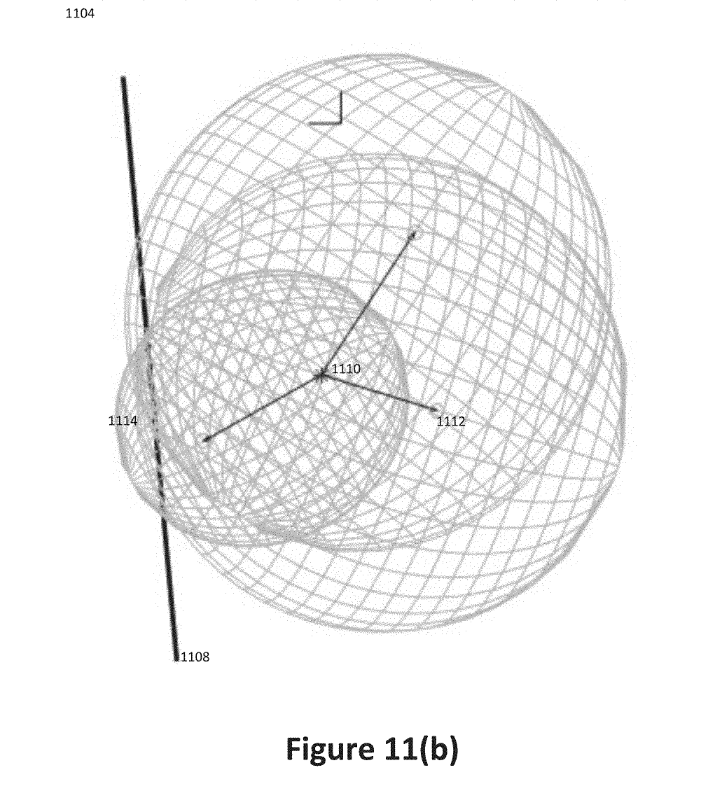

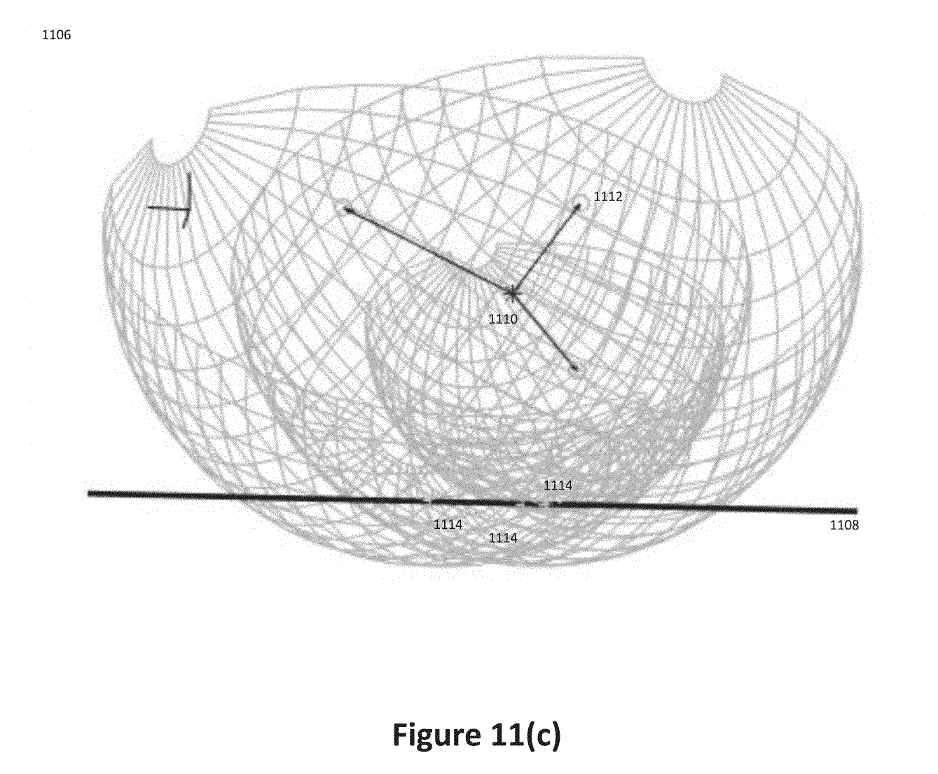

Using the sound speed model and the arrival times generated as part of signal processing, the locations of possible structures are iteratively determined by generating arrival time surfaces for each arrival time for each receiver (or beam). This generates a total number of arrival time surfaces equal to the total number of arrival times. Beam information (both transmitter and receiver beams, if any) is incorporated with the arrival time surfaces to get a general idea of the subsurface structure locations. Then different geometric constraints are applied to link the locations into coherent structures such as pipes, tank surfaces or valves. For example, a pipe structure will have arrival time surfaces that are mutually tangent to the pipe structure (see, for example, FIGS. 11 (a), (b), and (c)). Similarly, a large tank surface will have arrival time surfaces that are tangent to a plane (or cylinder). Numerical tests have been developed for these different tangency conditions. For point-like objects, the arrival time surfaces will intersect at the location of the object, which is the simplest test (see, for example, FIGS. 10 (a), (b), (c), (d), and (e)). These tests are ordered from the highest dimension to the lowest (i.e., planes, then lines, then points) and structures that are found are recorded. Then the receiver/beam/arrival times are re-ordered and the geometric search is performed again. Structures that are consistent across these orderings have a higher confidence, and the ones that change around are reprocessed to see if they fit with the more stable structures.

The above described signal and locations processing are shown in FIGS. 10 (a), (b), (c), (d), and (e).

FIG. 10 (a) shows the display of the collection geometry with one transmitter, four distributed single receivers and a series of buried point objects in various two- and three-dimensional views. FIG. 10 (b) shows the transmitted signal 1010 and a first received signal 1012, a second received signal 1014, a third received signal 1016, and a fourth received signal 1018. The data used in FIGS. 10 (a), (b), (c), (d), and (e) is modeled data and not data collected in the field, and is presented for illustrative purposes. FIG. 10 (c) shows the elliptical shell in a three-dimensional graph 1022 generated from a constant-speed model based on the arrival time computed from the received signal 1012. FIG. 10 (d) shows the shells from receive signals 1012 and 1014 in a three-dimensional graph 1026. FIG. 10 (e) shows the three shells from receive signals 1012, 1014, and 1016 in a three-dimensional graph 1028. The object is located at the mutual intersection of the three shells. This process is repeated algorithmically for all received signals and corresponding list of objects and their 3D locations built.

These ellipsoids all intersect at one point, which is the location of the buried object that generated that return. Since there is more than one ellipsoid in the example, the leading signal is removed and the process is repeated and all the other objects are found and all the locations matched with the example input. Once an object is located, the signals associated with that particular object no longer need to be considered. So, the original signals from each received have this part of their time series modified to effectively remove this part from further processing at this stage. The remaining time series contain signals from other objects and the same processing sequence is used to locate them. So, the “leading signal” is the signal associated with the found object. This ensures that the iterative process used does not continually find the same object.

A second illustration of the processing algorithm according to embodiments appears in FIGS. 11 (a), (b), and (c). In this case, the buried object is a pipe 1108. This example has one transmitter 1110 and four single receivers 1112 and a constant speed model is used for clarity. One difference between this example and the point example of FIG. 10 is that the arrival time surfaces do not mutually intersect but are tangent to a common line. This is more mathematically involved to implement than a common intersection, as the number of variables is larger and the mathematical relationships require working with pairs of arrival time surfaces, rather than one at a time. The algorithm reproduces the example parameters within the tolerances of the geometry.

The arrival time ellipsoids 1102, 1104, and 1106 are respectively shown in FIGS. 11 (a), (b), and (c). Tangent points 1114 are shown in FIGS. 11 (a), (b), and (c) that are used to locate the pipe 1108. In FIGS. 11 (b) and (c) note that only three receivers 1112 are used.

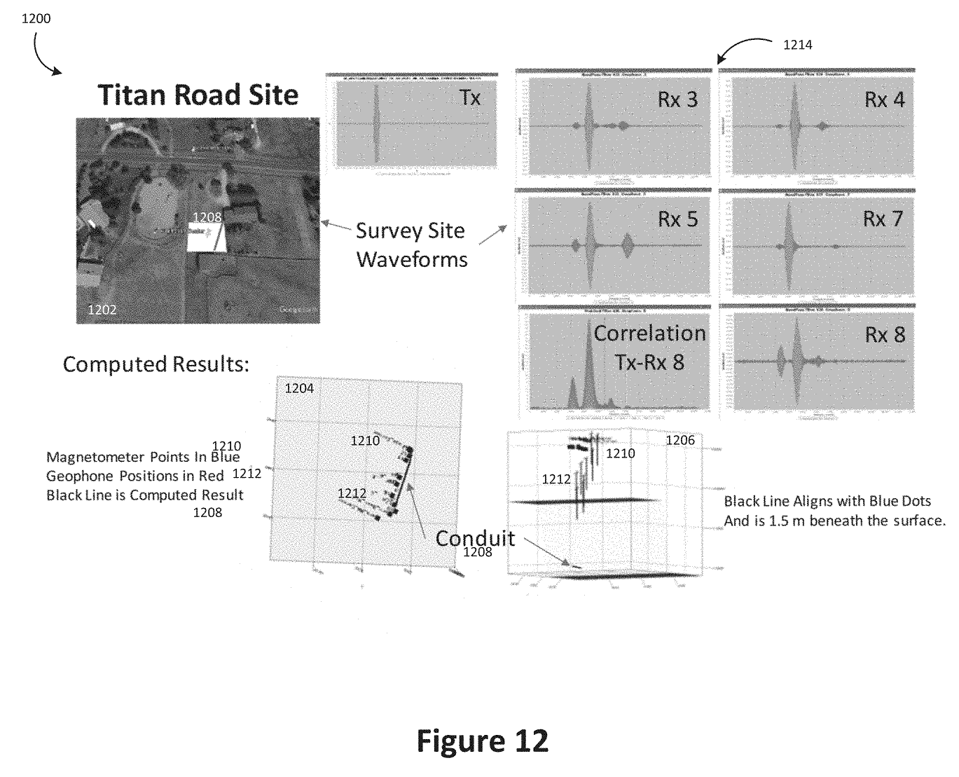

FIG. 12 shows sample waveforms, correlation output and the internal format used as an input to mapping for a field collection. Receiver numbers are sequential, and data was collected in two passes with four receivers in each pass. FIG. 12 shows the plan view 1202 of a survey site, transmit signal TX, receive signals Rx 3, Rx 4, Rx 5, Rx 7, and Rx 8, as well as a correlation signal of the transmit and one of the receive signals Tx-Rx 8. Also shown are the computed results including magnetometer points 1210, geophone positions 1212, and the computed result of the conduit 1208. The magnetometer points are measured locations using a conventional locating technique different than the one described herein, and is used for verification purposes.

In the example of FIG. 12, data was collected and processed by a field unit and located a structure which was a plastic conduit 1208 containing power lines run from a house to a barn. The collection was performed with two transmitter locations and eight single receiver measurement positions. The same processing algorithm described above was used in this example, working from planar structures to linear structures to point objects. The conduit 1208 was located and the results were verified with a commercially available active signal wand from Schonstedt. The location estimates matched the wand results within expected tolerances. The map of the site 1202 is shown in FIG. 12, as well as the received signals and a correlation to estimate arrival time as well as other signals 1214 previously described. The computed location 1204 is shown and the probe measurements are plotted on the surface map 1206.

Once the objects are located, a geometric correlation process is performed that links segments together that represent extended objects such as pipes, tanks, plates and so forth. The segments are linked together to identify corners, T-junctions, and changes in dimensionality (such as a pipe entering a tank). The algorithms are adapted from collision-detection and real-time computer graphics used in video games and look for intersections and splits. The linking process is straightforward, if computationally intensive. Once the structures are linked, an object list is built using an internal representation of the position, size, and orientation of each structure and store this as a list of subsurface objects.

The last part of the location processing involves refining the positions of the objects in the list by computing a receive signal for each receiver using the current geometry. Summing these signals for all the objects, a “forward signal model” is generated for each receiver. This forward signal is then compared pointwise to the actual receiver data and a difference-minimization search over the geometric parameters (location, size, orientation) is performed to fine-tune the location information. This refined position is then recorded as the location for the object and the forward signal is removed from all the received signals and the process repeated for each object found in the previous step.

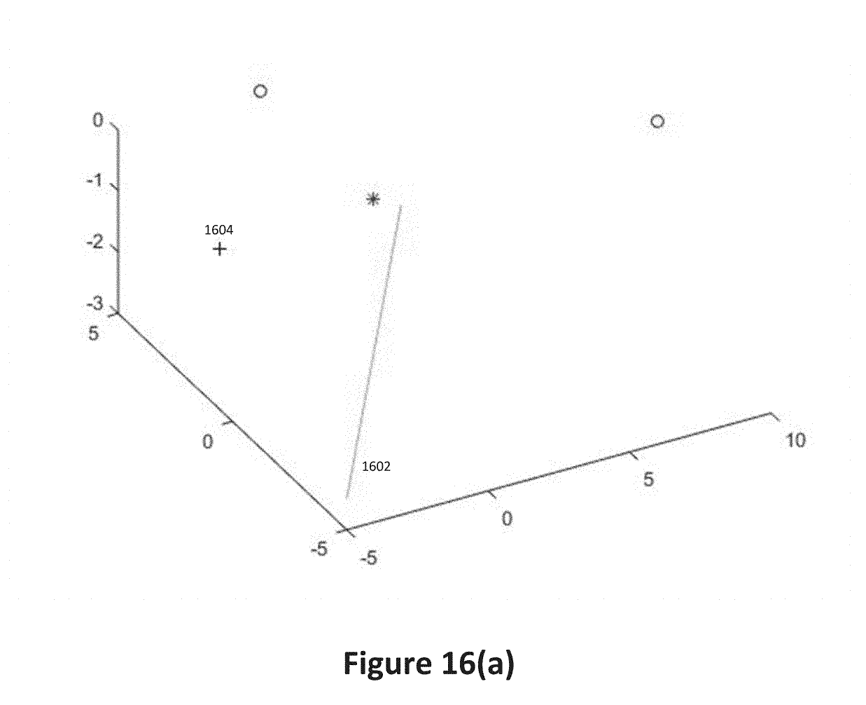

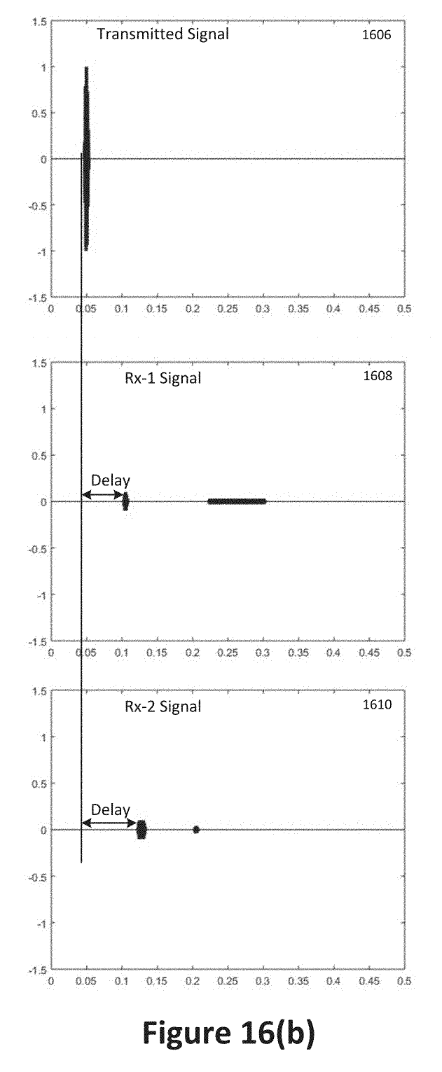

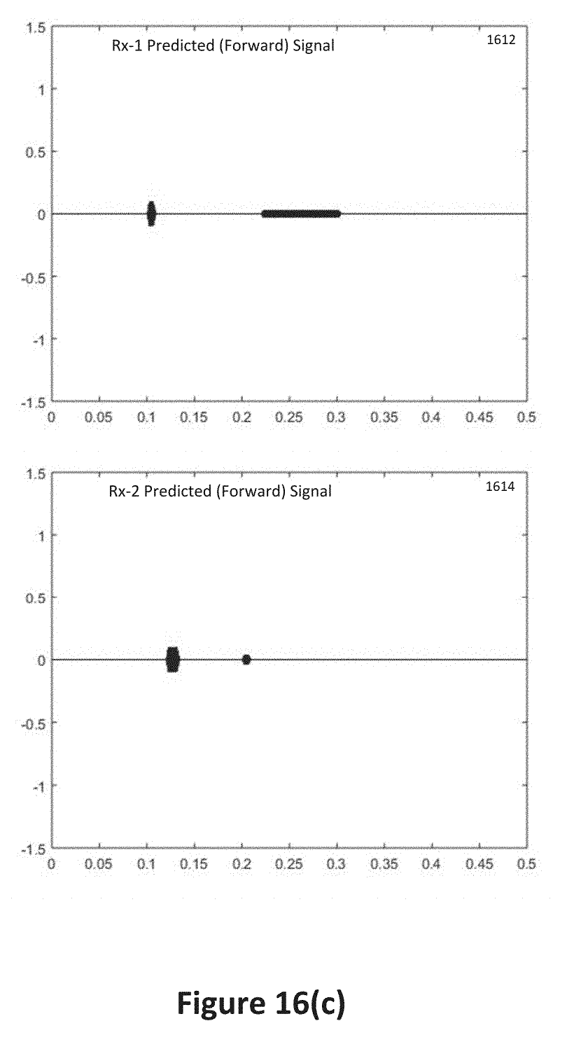

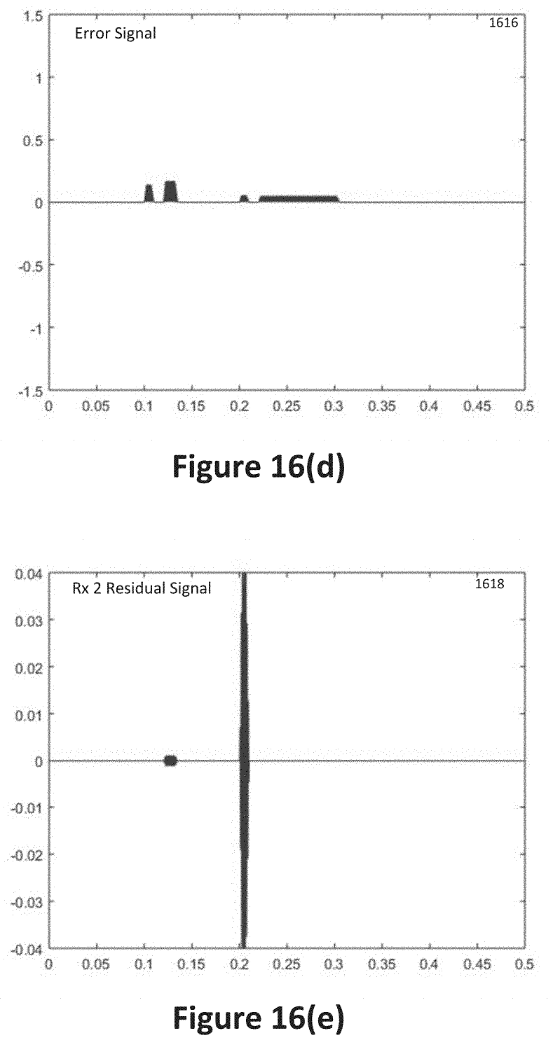

Referring now to FIGS. 16 (a), (b), (c), (d), and (e), further details of the precise locating approach are described, according to an embodiment. FIG. 16 (a) is a layout showing a single transmitter (Tx), two receivers (Rx-1, Rx-2), and two underground structures (a pipe 1602 and a point 1604). These underground structures have been located and oriented by an initial locating algorithm. FIG. 16 (b) shows, based on the initial geometry, generating predicted signals 1608 and 1610 that should be received at each receiver based on the transmitted signal 1606. FIG. 16 (c) shows the actual received signals 1612 at Rx-1 and 1614 at Rx-2. FIG. 16 (d) shows the error signal 1616 that is formed as the difference between predicted and received signals at Rx-1, and at Rx-2, and then combined as a root-mean-square. This error signal 1616 is then minimized by adjusting the position and orientation of the located structures, one at a time. Once a minimum is obtained, the predicted signal is subtracted from the actual signal to leave residual signals 1618 and 1620, shown in FIG. 16 (e). This process is repeated for the next structure using the residual signal as an “actual signal” until all the structures have been adjusted and the error signal minimized. These adjusted structure positions and orientations constitute the final locations.

The location data is stored in an internal format at this stage. The format for a point object is (x, y, z) coordinate values in meters defined by an east-north-up frame with origin at the site reference point, specified as part of the collection data. This reference point serves as the geodetic tie-in point and it has high-precision GPS location information associated with it, including latitude, longitude and altitude, all to a precision within a few inches. Linear objects and line segments are stored as (x, y, z, az, el, length) with x, y, z being the coordinates of the endpoint of the segment having extent given by length and oriented relative to the east-north-up frame with spherical polar angles “az” for the polar angle and el for the elevation angle measured from up. Planar objects are stored as (x, y, z, nx, ny, nz, length1, length2) with x, y, z being the coordinates of the middle of the surface, nx, ny, nz being the coordinates of the unit normal vector to the surface and length1,length2 being the extents perpendicular to the normal. For planar objects, the extent is an open issue as the surface may not be rectangular. These internal representations are used only within the processing and get translated to interchangeable quantities in the final processing step.

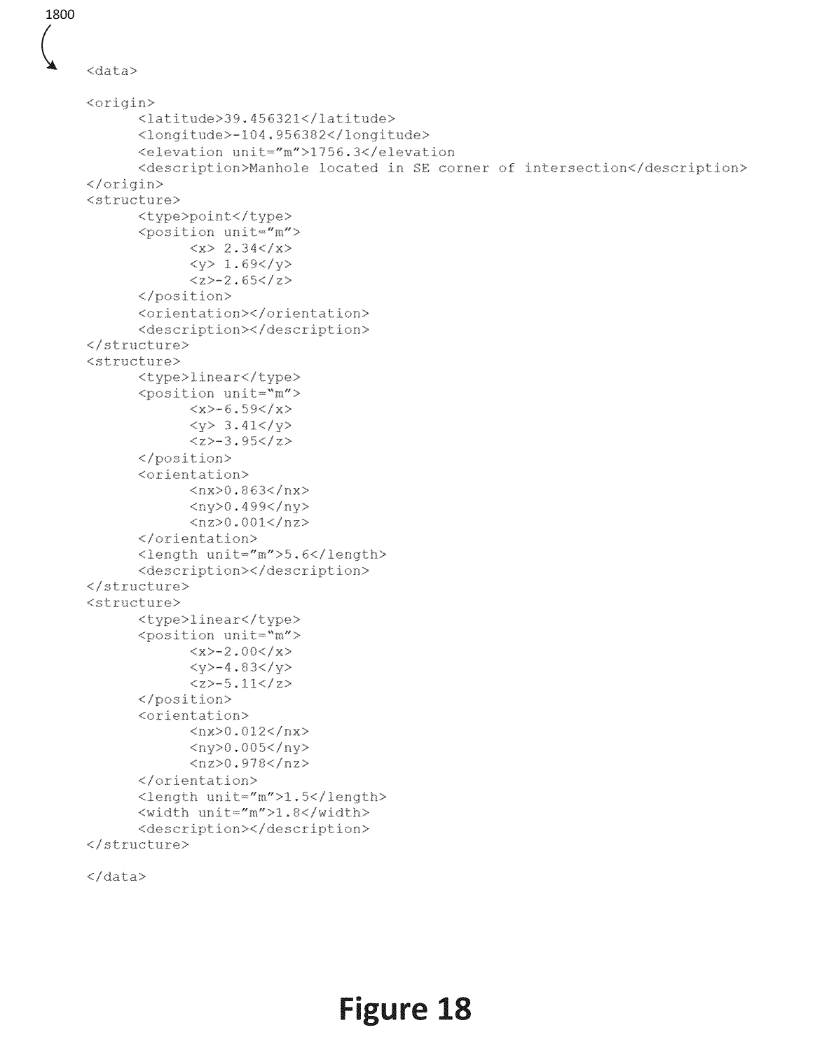

FIG. 18 shows an example of a notional data format 180o, which illustrates how the data description could be implemented. Various other data formats could be used in actual implementations as would be known by those skilled in the art.

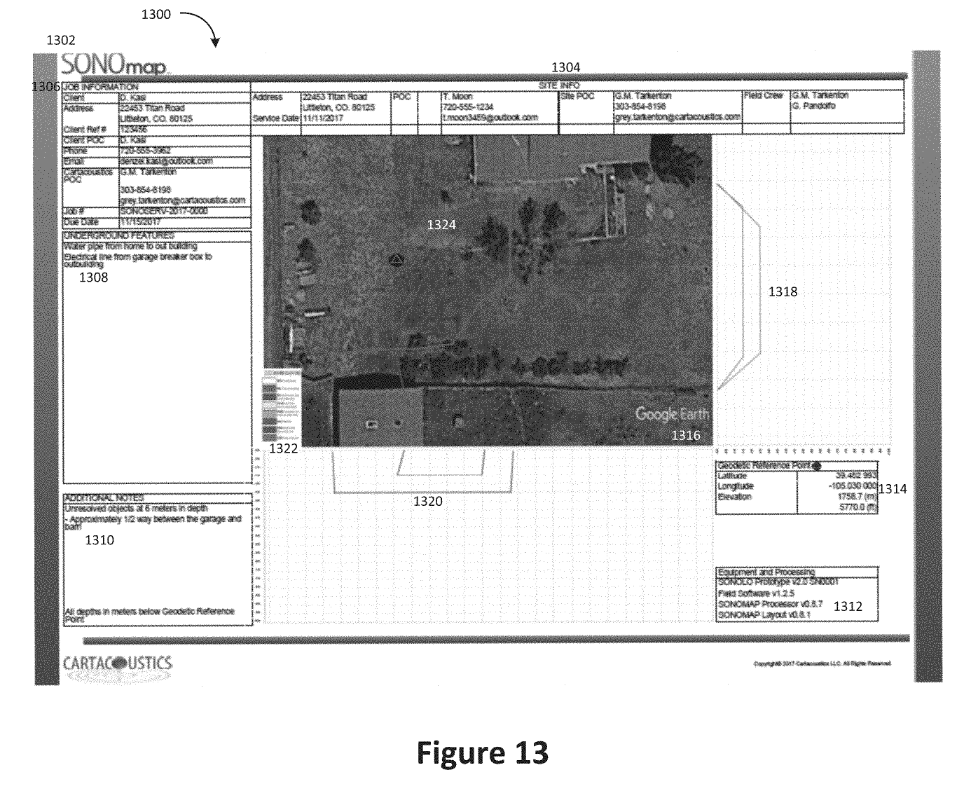

The last stage of processing translates the internal 3D representation of the underground objects into the hardcopy map format as is shown in FIG. 13 and into industry-standard 3D output formats in data files that can be delivered to a customer.

FIG. 13 thus shows an example of an output data product 1302 used for hard-copy or data file delivery. This is the end-product of the processing chain typically delivered to a customer. It is accompanied by digital products in one of a number of industry-standard formats such as ESRI shapefiles, Google's Keyhole Markup Language (“KML”), CAD files and BIM files. The data product 1302 includes a site information portion 1304, job information portion 1306, an underground feature portion 1308, additional notes portion 1310, equipment and processing portion 1312, geodetic reference points 1314, a plan view of the surveyed site 1316 as well as reconstructed views 1318 (two dimensional in the Y-axis vs depth), 1320 (two dimensional in the X-axis vs depth), and a plan view 1324. An index 1322 is shown to match the color of the infrastructure to an infrastructure type. The index 1322 would use industry standard colors used to designate function, in an embodiment. For example blue could be used to designate water, red to designate power, yellow to designate natural gas, and the like.

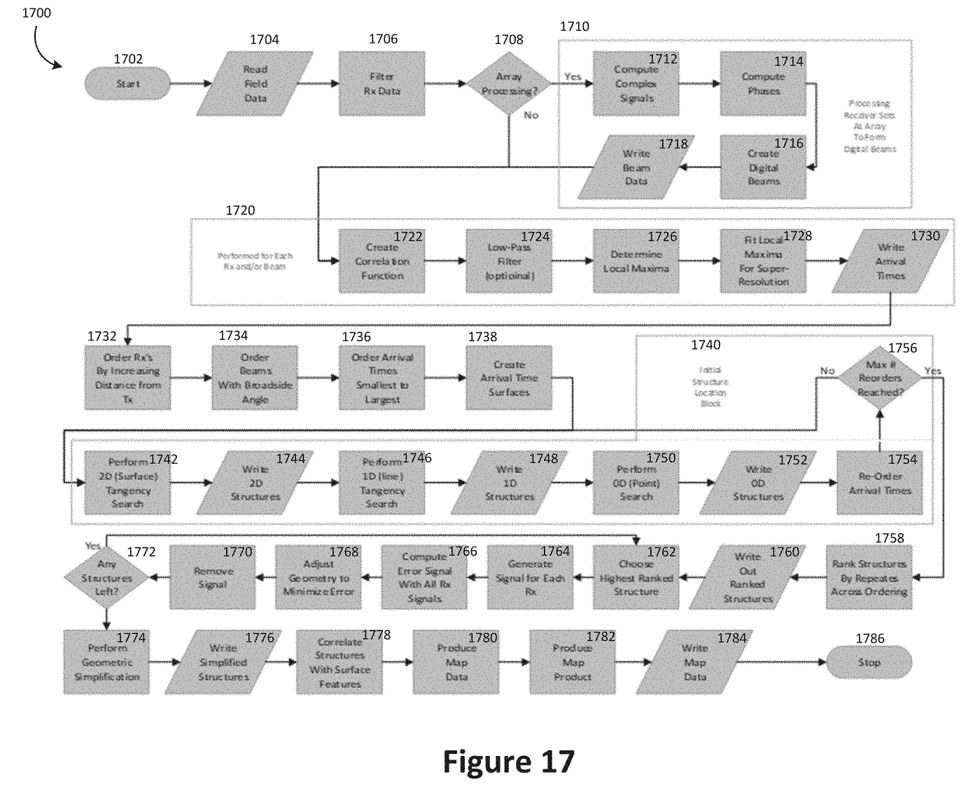

Referring now to FIG. 17, a signal processing flow chart algorithm 1700 is shown that can be used with the previously described signal processing methods, which starts at step 1702, reading the field data at step 1704, and filtering the receive data at step 1706. Step 1708 interrogates whether or not array processing is used. If yes, the method continues processing receiver sets as an array to form digital beams at 1740, including computing complex signals at 1712, computing phases at step 1714, creating digital beams at step 1716, and writing beam data at step 1718, and continuing on to a series of steps that are performed for each receive signal and/or beam at 1720. Returning to step 1708, if no, then the method proceeds directly to method portion 1720. Method portion 1720 includes creating correlation functions at step 1722, optional low-pass filtering at step 1724, determining local maxima at step 1726, fitting local maxima for super-resolution at step 1728, and writing arrival times at step 1730. The method continues to order receive signals by increasing distance from the transmitter at step 1732, ordering beams by broadside angle at step 1734, ordering arrival times from smallest to largest at step 1736, and creating arrival time surfaces at step 1738. The method then continues to an initial structure location block 1740, including performing a two-dimensional (surface) tangency search at step 1742, writing two-dimensional structures at step 1744, performing a one-dimensional (line) tangency search at step 1746, writing one-dimensional structures at step 1748, performing a zero-dimensional (point) search at step 1750, writing zero-dimensional structures at step 1752, and re-ordering arrival times at step 1754. Step 1756 interrogates whether or not a maximum number of reorders has been reached. If not, then the method returns to performs steps 1742 through 1754. If yes, then the method proceeds to rank structures by repeats across ordering at step 1758, writing out the ranked structures at step 1760, choosing the highest ranked structure at step 1762, generating a signal for each receive signal at step 1764, computing an error signal with all receive signals at step 1766, adjusting geometry to minimize error at step 1768, and removing signals at step 1770. Step 1772 interrogates whether or not there are any remaining structures. If yes, then steps 1762 through 1770 are repeated. If not, then geometric simplification is performed at step 1774, writing simplified structures at step 1776, correlating structures with surface features at step 1778, producing map data at step 1780, producing a map product at step 1782, and writing map data at step 1784. The method is then completed at the stop step 1786.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. An acoustic system for detecting underground infrastructure comprising:
a controller configured for generating a plurality of analog transmit signals, receiving a plurality of analog receive signals, and digitizing and recording the plurality of receive signals;
a sonic transmitter having a first amplifier for amplifying the plurality of analog transmit signals, an actuator for converting the amplified plurality of analog transmit signals into a plurality of acoustic signals, and an adjustable impedance matching network configured for adjusting coupling of the plurality of acoustic signals to the ground;
a receiver having a sensor for detecting the plurality of acoustic signals and generating the plurality of analog receive signals in response thereto, and a second amplifier configured for amplifying the plurality of analog receive signals; and
a signal processing system configured for combining the digitized and recorded receive signals to generate position data of the detected underground infrastructure.

2. The acoustic system of claim 1, wherein the controller is configured for generating a plurality of transmit signals including pulsed and continuous signals, multiple frequency signals, chirp signals, signals having different pulse repetition frequencies, variable pulse lengths, arbitrary amplitude envelop profiles, and variable duty cycles.

3. The acoustic system of claim 1, wherein the sonic transmitter comprises a loudspeaker housed in a tube, an underwater speaker housed in a water column, or a steel rod actuator.

4. The acoustic system of claim 1, wherein the sensor comprises a geophone or microphone.

5. The acoustic system of claim 1, wherein the transmitter or receiver comprises a single emitter or sensor, respectively, or a plurality of emitters or sensors, respectively, in an array or random configuration.

6. The acoustic system of claim 1, wherein the signal processing system is configured for combining the digitized and recorded receive signals to generate position data of the detected underground infrastructure using a time difference of arrival model, an angle of arrival model, or constrained matched filter model.

7. The acoustic system of claim 1, wherein the position data of the detected underground infrastructure comprises a hard copy report or a data file.

8. A field method for collecting underground infrastructure data comprising:
in a field location,
generating a plurality of analog transmit signals;
amplifying the plurality of analog transmit signals to generate a plurality of acoustic signals;
applying the plurality of acoustic signals to the field location;
receiving a plurality of analog receive signals; and
digitizing and recording the plurality of receive signals.

9. The method of claim 8, wherein generating the plurality of analog transmit signals are transmitted by a transmitter comprising a single emitter.

10. The method of claim 8, wherein generating the plurality of analog transmit signals are transmitted by a transmitter comprising a plurality of emitters.

11. The method of claim 8, wherein generating the plurality of analog transmit signals comprises generating pulsed and continuous signals, multiple frequency signals, chirp signals, signals having different pulse repetition frequencies, variable pulse lengths, variable duty cycles, and pulse shapes.

12. The method of claim 8, wherein the plurality of analog receive signals are received by a single receiver or a group of receivers sequentially placed in a random pattern, a regular array pattern, or a linear array.

13. The method of claim 8, further wherein the steps of generating and receiving comprise using at least one transmitter and at least one receiver, and wherein relative positioning of the at least one transmitter in relation to the at least one receiver comprises GPS, Bluetooth, WiFi, or surveying methods of relative positioning.

14. The method of claim 8, further comprising adjusting the coupling of the plurality of acoustic signals to the field location.

15. A method of processing recorded acoustic signals and transmitter and receiver geometric data, the method comprising:
combining digitized and recorded receive signals;
generating arrival time surfaces from the combined digitized and recorded receive signals; and
processing the arrival time surfaces to generate position data of the detected underground infrastructure.

16. The method of claim 15, wherein generating the arrival time surfaces comprises using a time difference of arrival model, an angle of arrival model, or constrained matched filters.

17. The method of claim 15, wherein processing the arrival time surfaces comprises determining intersections, linear tangency, planar tangency, cylindrical tangency, or spherical tangency of the arrival time surfaces.

18. The method of claim 15, wherein generating the arrival time surfaces comprises using a constant, linear, or continuously changing sound speed model.

19. The method of claim 15, wherein generating the position data of the detected underground infrastructure comprises geometric simplification including correlating the position data to a geometric structure.

20. The method of claim 15, further comprising iteratively using the arrival time surfaces to locate at least one underground infrastructure object.
